(19) United States
(12) Patent Application Publication
(10) Pub. No.: US 2008/0067936 A1
(43) Pub. Date: Mar. 20, 2008

(54) Color display device

(75) Inventors: Manabu Ishimoto, Kobe (JP); Hitoshi Hirakawa, Kobe (JP); Yosuke Yamazaki, Kobe (JP); Koji Shinohe, Kobe (JP); Kenji Awamoto, Kobe (JP)

Correspondence Address: STAAS & HALSEY LLP, SUITE 700, 1201 NEW YORK AVENUE, N.W., WASHINGTON, DC, 20005, US

(73) Assignee: SHINODA PLASMA CO., LTD., Hyogo (JP)

(21) Appl. No.: 11/984,536

(22) Filed: Nov. 19, 2007

Related U.S. Application Data
(63) Continuation of application No. PCT/JP05/09227, filed on May 20, 2005.

(51) Int. Cl. H01J 17/49

(52) U.S. Cl. 313/582

(57) ABSTRACT

A color display device (10) includes: a plurality of gas discharge tubes disposed side by side, the gas discharge tubes having phosphor layers (4R, 4G, 4B) of different materials for respective colors disposed therein and containing discharge gas therein, the gas discharge tubes each having a plurality of light-emitting points disposed along the length thereof; a plurality of display electrodes disposed on display-side surfaces of the gas discharge tubes; and a plurality of signal electrodes (3) disposed on the rear sides of the respective gas discharge tubes. Those ones of the gas discharge tubes which include a same, particular material in the phosphor layers (4R, 4G, 4B) thereof have voltage adjusting layers (6R, 6B) disposed between rear surfaces and the signal electrodes thereof. The voltage adjusting layers are made of a material which adjusts a firing voltage for discharge between the display electrodes and the signal electrodes. The thicknesses of the voltage adjusting layers for the plurality of gas discharge tubes including the different materials in the respective phosphor layers thereof are so selected as to reduce differences in firing voltage, among the plurality of gas discharge tubes.

This application is a continuation application of international application PCT/JP2005/009227 filed may 20, 2005.

### FIELD OF THE INVENTION

The present invention relates generally to a color display device having color phosphor layers, and, more particularly, to a color display device employing discharge-induced light-emission elements having phosphor layers of different materials.

### BACKGROUND ART

A plasma tube array (PTA) and a plasma display panel (PDP) are known as a thin color display device employing discharge-induced light-emission elements (see JP 2004-178854-A).

G. Oversluizen et al. disclose, in “5.1 High Efficiency PDP”, SID (Society for Information Display), 03 DIGEST, 2003, pp. 28-31, that the emission efficiency and luminosity of a PDP can be increased by providing a layer of titanium dioxide (TiO₂) under a phosphor layer of the PDP.

### DISCLOSURE OF THE INVENTION

Discharge-induced light-emission elements having phosphor layers of different materials have a problem that discharge voltage characteristics differ for the different phosphor materials so that the drive margin for the elements becomes narrower. Particularly, the problem is that characteristics of discharge occurring through a phosphor layer between the electrodes greatly differ for the different phosphor materials. Hence, even when the same voltage is to be applied across the elements with the different phosphor materials, the phosphor materials have different discharging conditions, so that the common drive margin becomes narrow.

Specifically, a plasma tube array, which is formed by arranging, side by side, a number of thin elongated gas discharge tubes (plasma tubes) of three types respectively having R, G and B phosphors formed therein, include longitudinally extending address electrodes contacting the outer walls of the tubes, and also include pairs of display electrodes extending transversely to the tubes provided on the outer wall surfaces of the tubes opposite to the address electrodes. Accordingly, the distance between the address electrodes and the display electrodes sandwiching the tubes is generally equal to the diameter of the tubes, which may be, for example, in the order of 500 μm. This dimension is significantly larger than the discharge gap between address and display electrodes of a common PDP of a three-electrode surface discharge type, and necessarily requires a higher voltage for the address discharge.

In a color display device of a plasma tube array type, in particular, the inner spaces of the respective discharge tubes are independent of each other, and hence there is no coupling between laterally adjacent cells, which is different from the coupling between laterally adjacent cells in the common PDP, so that the variations of the discharge voltages of the tubes due to the difference in phosphor materials tend to be more noticeable. Thus, because of the requirements of high addressing voltages for the tubes and the variations of the discharge voltages due to the different phosphor materials, a color display device of a plasma tube array type, in particular, requires a drive voltage margin to be large in absolute value, which should desirably be improved.

An object of the present invention is to correct variations of discharge voltage characteristics of different color phosphor materials of discharge light emission elements of a display device.

Another object of the invention is to provide an increased drive margin for a display device having different phosphor layers.

### SUMMARY OF THE INVENTION

In accordance with an aspect of the present invention, a color display device includes: a plurality of gas discharge tubes disposed side by side, the gas discharge tubes having phosphor layers of different materials for respective colors disposed therein and containing discharge gas therein, the gas discharge tubes each having a plurality of light-emitting points disposed along the length thereof; a plurality of display electrodes disposed on display-side surfaces of the gas discharge tubes; and a plurality of signal electrodes disposed on the rear sides of the respective gas discharge tubes. Those ones of the gas discharge tubes which include a same, particular material in the phosphor layers thereof have voltage adjusting layers disposed between rear surfaces and the signal electrodes thereof. The voltage adjusting layers are made of a material which adjusts a firing voltage for discharge between the display electrodes and the signal electrodes. The thicknesses of the voltage adjusting layers for the plurality of gas discharge tubes including the different materials in the respective phosphor layers thereof are so selected as to reduce or minimize differences in firing voltage, among the plurality of gas discharge tubes.

In accordance with another aspect of the invention, in the color display device, dimensions of the gas discharge tubes are so selected, depending on the materials of the respective phosphor layers, as to reduce differences in firing voltage for discharge between the display electrodes and the signal electrodes in the plurality of gas discharge tubes.

In accordance with a further aspect of the invention, in the color display device, the widths of the signal electrodes for the gas discharge tubes are so selected for the materials of the respective phosphor layers, as to reduce differences in firing voltage for discharge between the display electrodes and the signal electrodes in the plurality of gas discharge tubes.

In accordance with a still further aspect of the invention, in the color display device, materials of the gas discharge tubes are so selected for the materials of the respective phosphor layers, as to reduce differences in firing voltage for discharge between the display electrodes and the signal electrodes in the plurality of gas discharge tubes.

According to the invention, in a display device having different color phosphor materials, the variations of discharge voltage characteristics of different color phosphor materials can be corrected, and the drive margin can be increased. In particular, the invention can be advantageously applied to a color display device of a plasma array tube type with independent discharge spaces for different colors, for narrowing differences of the discharge voltages for different color tubes and increasing the drive margin.

### BRIEF DESCRIPTION OF THE DRAWINGS

FIG. 1 shows an example of the structure of part of a large display device, in accordance with an embodiment of the present invention;

FIG. 2A shows a front support with a plurality of pairs of transparent display electrodes formed thereon, and

FIG. 2B shows a rear support with the plurality of signal electrodes formed thereon;

FIG. 3 shows the cross-section of the structure of a display device in a plane perpendicular to the longitudinal direction, in accordance with an embodiment of the invention;

FIG. 4 shows the cross-section of the structure of a display device in a plane perpendicular to the longitudinal direction, in accordance with another embodiment of the invention;

FIG. 5 shows the cross-section of the structure of a display device in a plane perpendicular to the longitudinal direction, in accordance with a further embodiment of the invention;

FIG. 6 shows the cross-section of the structure of a display device in a plane perpendicular to the longitudinal direction, in accordance with a still further embodiment of the invention;

FIG. 7 shows the cross-section of the structure of a display device in a plane perpendicular to the longitudinal direction, in accordance with a still further embodiment of the invention;

FIG. 8 shows the cross-section of the structure of a display device in a plane perpendicular to the longitudinal direction, in accordance with a still further embodiment of the invention;

FIG. 9 shows firing voltages for opposite discharge in the gas discharge tubes, according to the prior art technique;

FIG. 10 shows firing voltages for opposite discharge in the gas discharge tubes of the display device of FIG. 6; and

FIG. 11 shows the firing voltages for opposite discharge in the different gas discharge tubes for the display device.

### DESCRIPTION OF THE PREFERRED EMBODIMENTS

The invention will be described with reference to the accompanying drawings. Throughout the drawings, similar symbols and numerals indicate similar items and functions.

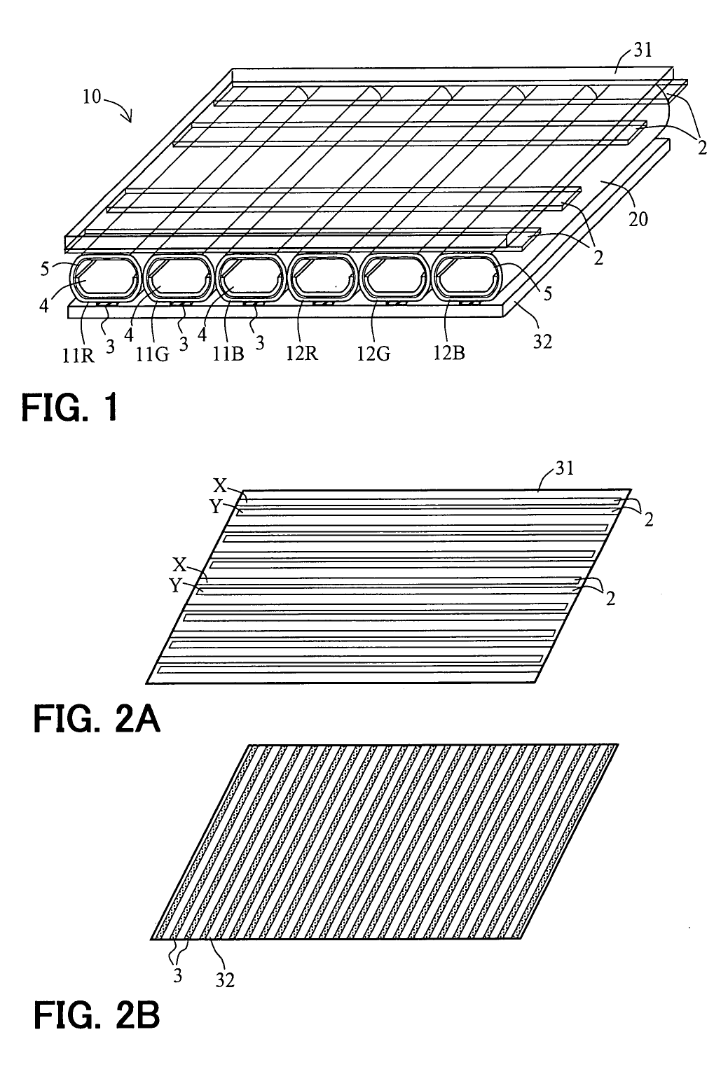

FIG. 1 shows an example of the structure of part of a color display device 10 of a plasma tube array type, in accordance with an embodiment of the present invention. In FIG. 1, the display device 10 includes a plurality of thin, elongated transparent gas discharge tubes 11R, 11G, 11, 12R, 12G, 12B, . . . , disposed in parallel with each other, a front support plate 31 composed of a transparent front support sheet or thin plate, a rear support plate 32 composed of a transparent or opaque rear support sheet or thin plate, a plurality of pairs of display or main electrodes 2, and a plurality of signal electrodes 3. Letters R, G and B represent red, green and blue, which are colors of light emitted by the phosphors. The front and rear support plates 31 and 32 are made of, for example, flexible or elastic PET or glass films or sheets.

The thin, elongated gas discharge tube 11R, 11G, 11B, . . . is formed of a transparent insulating material, e.g. borosilicate glass, and, typically, has cross-section dimensions of a tube diameter of 2 mm or smaller, for example a 0.5 mm high and 1 mm wide cross section, and a tube length of 300 mm or larger.

Typically, phosphor support members having respective red, green and blue (R, G, B) phosphor layers 4 formed or deposited thereon are inserted into the interior discharge spaces of the gas discharge tubes 11R, 11G, 11B, . . . , respectively. Discharge gas is introduced into the interior discharge space of each gas discharge tube, and the gas discharge tube is sealed at its opposite ends. An electron emissive film 5 of MgO is formed on the inner surface of the gas discharge tube 11R, 11G, 11B, . . . , and a support member with a phosphor layer 4 formed thereon is disposed within the gas discharge tube 11R, 11G, 11B, . . . . Alternatively, the respective phosphor layers 4 may be formed on the rear inner surface portions of the gas discharge tubes 11R, 11G, 11B, . . . , without using the support members. The phosphor layers R, G and B typically have a thickness within a range of from about 30 μm to about 50 μm.

The support member is formed of a transparent insulating material, e.g. borosilicate glass, and has the phosphor layer 4 formed thereon. The support member may be disposed within the glass tube by applying a paste of phosphor over the support member outside the glass tube and then baking the phosphor paste to form the phosphor layer 4 on the support member, before inserting the support member into the glass tube. As the phosphor paste, a desired one of various phosphor pastes known in this technical field may be employed.

The electron emissive film 5 emits charged particles, when it is bombarded with the discharge gas. When a voltage is applied between the pair of display electrodes 2, the discharge gas contained in the tube is excited. The phosphor layer 4 emits visible light by converting thereinto vacuum ultraviolet radiation generated in the de-excitation process of the excited rare gas atoms.

FIG. 2A shows the front support 31 with the plurality of pairs of transparent display electrodes 2 formed thereon. FIG. 2B shows the rear support 32 with the plurality of signal electrodes 3 formed thereon.

The signal electrodes 3 are formed on the front-side surface, or inner surface, of the rear support plate 32, and extend along the longitudinal direction of the gas discharge tubes 11R, 11G, 11B, . . . . The pitch, between adjacent ones of the signal electrodes 3, is equal to the width of each of the gas discharge tubes 11R, 11G, 11B, . . . , which may be, for example, 1 mm. The pairs of display electrodes 2 are formed on the rear-side surface, or inner surface, of the front support plate 31 in a well-known manner, and are disposed to extend across the signal electrodes 3. The width of the display electrodes 2 may be, for example, 0.75 mm, and the distance between the edges of the display electrodes 2 in each pair may be, for example, 0.4 mm. A distance providing a non-discharging region, or non-discharging gap, is secured between one display electrode pair 2 and the adjacent display electrode pairs 2, and the distance may be, for example, 1.1 mm.

The signal electrodes 3 and the pairs of display electrodes 2 are brought into intimately contact respectively with the lower and upper peripheral surface portions of the gas discharge tubes 11R, 11G, 11B, . . . , when the display device 10 is assembled. In order to provide better contact, an electrically conductive adhesive may be placed between the display electrodes and the gas discharge tube surface portions.

In plan view of the display device 10 seen from the front side, the intersections of the signal electrodes 3 and the pairs of display electrodes 2 provide unit light-emitting regions. Display is provided by using either one electrode of each pair of display electrodes 2 as a scanning electrode, generating a selection discharge at the intersection of the scanning electrode with the signal electrode 3 to thereby select a light-emitting region, and generating a display discharge between the pair of display electrodes 2 using the wall charge formed by the selection discharge on the region of the inner tube surface at the selected region, which, in turn, causes the associated phosphor layer to emit light. The selection discharge is an opposed discharge generated within each gas discharge tube 11R, 11G, 11B, . . . between the vertically opposite scan electrode and signal electrode 3. The display discharge is a surface discharge generated within each gas discharge tube 11R, 11G, 11B, . . . between the two display electrodes of each pair of display electrodes disposed in parallel in a plane.

The pair of display electrodes 2 and the signal electrode 3 can generate discharges in the discharge gas within the tube by applying voltages between them. The electrode structure of the gas discharge tube 11 shown in FIG. 1 is such that the three electrodes are disposed in one light-emitting region, and that the discharge between the pair of display electrodes generates a discharge for display. However, the electrode structure is not limited to such a structure. A display discharge may be generated between the display electrode 2 and the signal electrode 3. In other words, an electrode structure of a type employing a single display electrode may be employed instead of each pair of display electrodes 2, in which the single display electrode 2 is used as a scanning electrode so that a selection discharge and a display discharge (opposed discharge) are generated between the single display electrode 2 and the signal electrode 3.

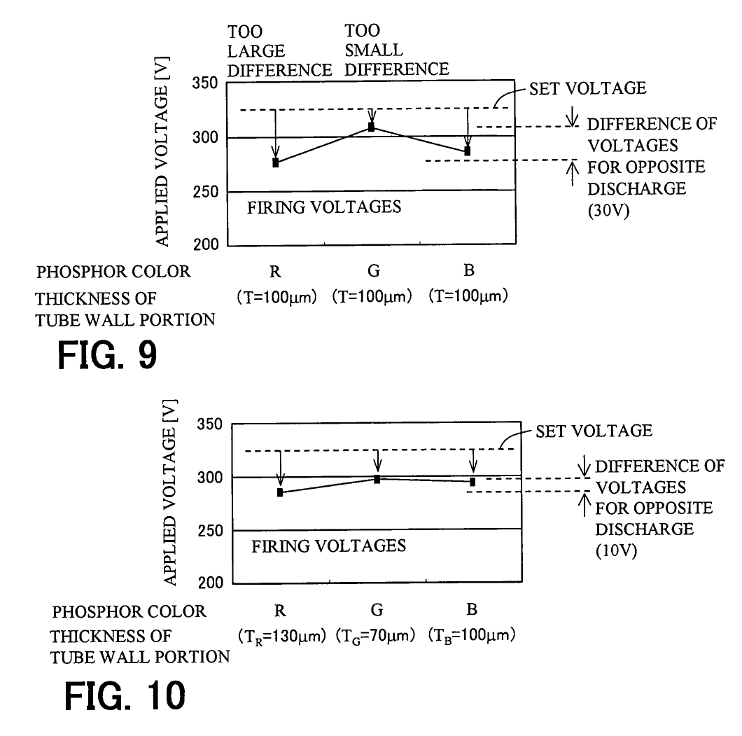

FIG. 9 shows firing voltages for opposite discharge between one display electrode 2 and the signal electrodes 3, for the gas discharge tubes 11R, 11G and 11B, according to the prior art technique, wherein phosphor layers 4 are formed on the rear-side inner surface portions of the gas discharge tubes 11R, 11G and 11B, the tube thickness is 100 μm, the width and height in the cross-section perpendicular to the longitudinal direction are 1.0 mm and 0.5 mm, respectively.

In FIG. 9, it is seen that, due to different properties of different color emitting phosphors, the firing voltage for opposite discharge in the red-emitting gas discharge tube 11R is the lowest, which is, for example, about 280 V, the firing voltage for opposite discharge in the green-emitting gas discharge tube 11G is the highest, which is, for example, about 310 V, and the firing voltage for opposite discharge in the blue-emitting gas discharge tube 11B is between the above-mentioned two voltages and closer to the voltage for the red-emitting gas discharge tube 11R, and is, for example, about 285 V. However, it is desirable that the difference in firing voltage for opposite discharge between the gas discharge tubes 11R, 11G and 11B be small. Usually, the difference in firing voltage for opposite discharge between the gas discharge tubes 11R, 11G and 11B is too large to be neglected, and is, for example, about 30 V. Accordingly, when the difference between the firing voltage for opposite discharge and the preset value of voltage to be applied is too large, an excessive discharge tends to be generated, sometimes causing an erasing discharge to occur, which, in turn, decreases the wall charge so that light cannot be emitted.

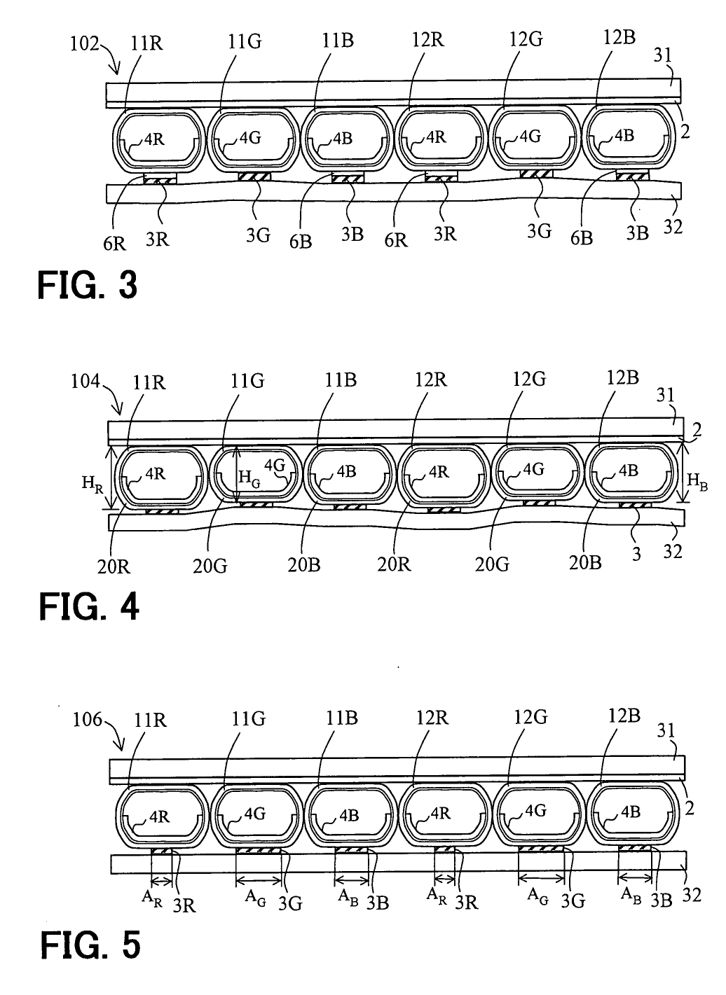

FIG. 3 shows the cross-section of the structure of a display device 102 in a plane perpendicular to the longitudinal direction, in accordance with an embodiment of the invention. In the display device 102, phosphor layers 4R, 4G and 4B are formed on the rear-side, inner surface portions of gas discharge tubes 11R, 11G and 11B, respectively, and the gas discharge tubes are thin tubes having a tube thickness of 100 μm, a width in the cross-section of 1.0 mm, and a height in the cross-section of 0.5 mm. For example, the red-emitting phosphor 4R may be formed of an yttria based material (Y₂O₃:Eu), the green-emitting phosphor 4G may be formed of a zinc silicate based material (Zn₂SiO₄:Mn), and the blue-emitting phosphor 4B may be formed of a BAM based material (BaMgAl₁₀O₁₇:Eu).

In FIG. 3, voltage adjusting layers 6R having a thickness of from about 5 μm to about 10 μm are formed between the bottom surfaces of the red-emitting gas discharge tubes 11R and 12R and the signal electrodes 3R disposed on the inner side of the rear support plate 32, and thicker voltage adjusting layers 6B having a thickness of from about 80 μm are formed between the bottom surfaces of the blue-emitting gas discharge tubes 11B and 12B and the signal electrodes 3B disposed on the inner side of the rear support plate 32. No voltage adjusting layer is formed between the bottom surfaces of the green-emitting gas discharge tubes 11G and 12G and the signal electrodes 3G disposed on the inner side of the rear support plate 32.

The materials for the voltage adjusting layers 6R and 6B are, for example, titanium dioxide (TiO₂) and tantalum pentoxide (TaO₅) . The voltage adjusting layers 6R and 6B are formed, by printing, vapor deposition or sputtering, on the signal electrodes 3 formed on the rear support plate 32.

The firing voltages for opposite discharge between the signal electrodes 3 of the gas discharge tubes 11G and 12G and the display electrodes 2 are about 310 V. The presence of the voltage adjusting layers 6R increases the firing voltage for opposite discharge between the signal electrodes 3 of the gas discharge tubes 11R and 12R and the display electrodes 2, by about 30 V, from about 280 V to about 310 V. The presence of the voltage adjusting layers 6B increase the firing voltage for opposite discharge between the signal electrodes 3 of the gas discharge tubes 11B and 12B and the display electrodes 2, by about 20 V, from about 290 V to about 310 V. Thus, the differences in firing voltage for opposite discharge, among the gas discharge tubes 11R, 11G, 11B, . . . , are small, and their firing voltages are generally equal.

FIG. 4 shows the cross-section of the structure of a display device 104 in a plane perpendicular to the longitudinal direction, in accordance with another embodiment of the invention. In FIG. 4, the height H_{R} in cross-section of red-emitting gas discharge tubes 11R and 12R is the largest relative to the heights in cross-section of the other color emitting tubes and is, for example, 0.5 mm. The height H_{G} in cross-section of green-emitting gas discharge tubes 11G and 12G is smaller than the height H_{R} in cross-section of the red-emitting gas discharge tubes 11R and 12R and is, for example, 0.4 mm. The height H_{B} in cross-section of blue-emitting gas discharge tubes 11B and 12B is smaller than the height H_{R} in cross-section of the red-emitting gas discharge tubes 11R and 12R, and is larger than the height H_{G} in cross-section of green-emitting gas discharge tubes 11G and 12G and is, for example, 0.45 mm.

The firing voltage for opposite discharge for the gas discharge tubes 11R and 12R is about 280 V for the cross-sectional height H_{R}. Because of the smaller cross-sectional height H_{G} employed for the gas discharge tubes 11G and 12G, the firing voltage for opposite discharge between the signal electrodes 3 of the gas discharge tubes 11G and 12G and the display electrodes 2 decreases by about 30 V from about 310 V down to about 280 V according to the reduced distance. Because of the smaller cross-sectional height H_{B} employed for the gas discharge tubes 11B and 12B, the firing voltage for opposite discharge between the signal electrodes 3 for the gas discharge tubes 11B and 12B and the display electrodes 2 decreases by about 10 V from about 290 V down to about 280 V according to the reduced distance. Thus, the firing voltages for opposite discharge for the gas discharge tubes 11R, 11G, 11B, . . . , are substantially equal, and the firing voltage differences among them become smaller.

FIG. 5 shows the cross-section of the structure of a display device 106 in a plane perpendicular to the longitudinal direction, in accordance with a further embodiment of the invention. In FIG. 5, the width A_{R} of the signal electrodes 3R for the red-emitting gas discharge tubes 11R and 12R is smaller and is, for example, 0.25 mm, whereas the width AG of the signal electrodes 3G for the green-emitting gas discharge tubes 11G and 12G is larger and is, for example, 0.5 mm. The width A_{B} of the signal electrodes 3B for the blue-emitting gas discharge tubes 11B and 12B is larger than the width A_{R} of the signal electrodes 3R for the red-emitting gas discharge tubes 11R and 12R and smaller than the width A_{G} of the signal electrodes 3G for the green-emitting gas discharge tubes 11G and 12G, and is, for example, 0.3 mm.

The firing voltage for opposite discharge for the gas discharge tubes 11B and 12B is about 290 V for the width A_{B} of the signal electrodes 3B. By virtue of employing the width A_{R} for the signal electrodes 3R for the gas discharge tubes 11R and 12R, which is smaller than the width A_{B}, the firing voltage for opposite discharge between the signal electrodes 3R for the gas discharge tubes 11R and 12R and the display electrodes 2 increases by about 10 V, from about 280 V up to about 290 V according to the decreased width. By virtue of employing the width A_{G} for the signal electrodes 3G for the gas discharge tubes 11G and 12G, which is larger than the width A_{B}, the firing voltage for opposite discharge between the signal electrodes 3G for the gas discharge tubes 11G and 12G and the display electrodes 2 decreases by about 10 V, from about 310 V down to about 300 V according to the increased width. Thus, the difference in firing voltage for opposite discharge, between the gas discharge tubes 11R, 11G, 11B, becomes smaller to about 10 V.

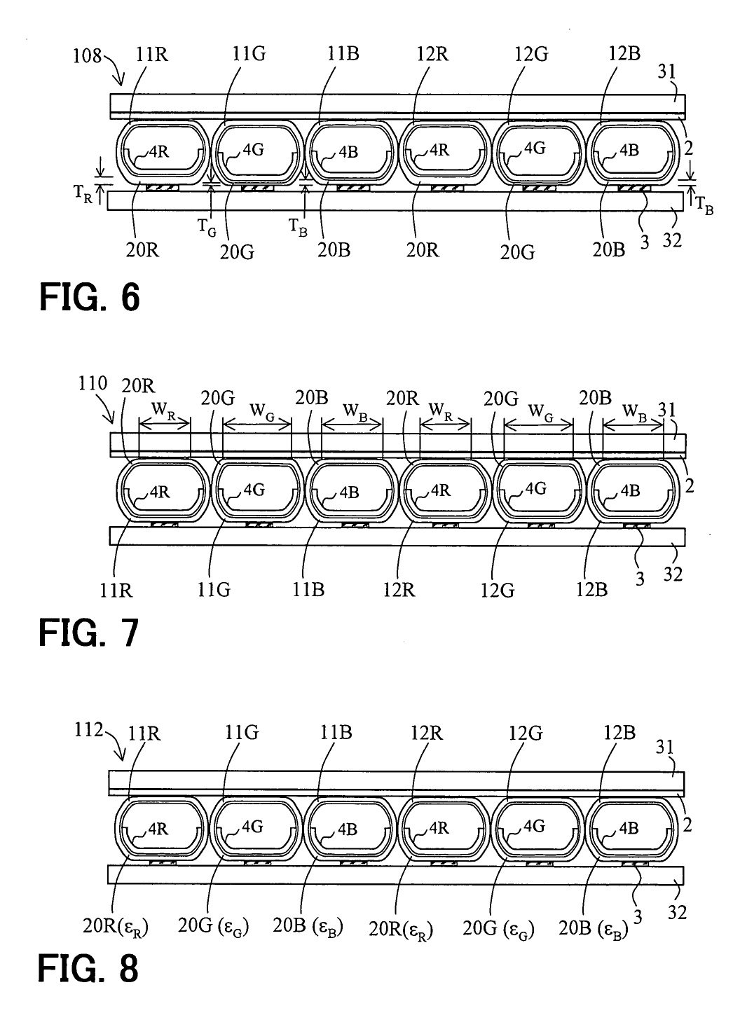

FIG. 6 shows the cross-section of the structure of a display device 108 in a plane perpendicular to the longitudinal direction, in accordance with a still further embodiment of the invention. In FIG. 6, the thickness T_{R} of the wall portions, closer to the signal electrodes 3, of the red-emitting gas discharge tubes 11R and 12R is larger and, for example, 0.13 mm. The thickness T_{G} of the wall portions, closer to the signal electrodes 3, of the green-emitting gas discharge tubes 11G and 12G is smaller and, for example, 0.07 mm. The thickness T_{B} of the wall portions, closer to the signal electrodes 3, of the blue-emitting gas discharge tubes 11B and 12B is smaller than the thickness T_{R} of the wall portions, closer to the signal electrodes 3, of the gas discharge tubes 11R and 12R and larger than the thickness T_{G} of the wall portions, closer to the signal electrodes 3, of the gas discharge tubes 11G and 12G and, for example, 0.1 mm.

FIG. 10 shows firing voltages for opposite discharge between one display electrode 2 and the signal electrodes 3 for the gas discharge tubes 11R, 11G and 11B of the display device 108.

Referring to FIG. 10, the firing voltage for opposite discharge in the gas discharge tubes 11B and 12B is about 285 V for the tube wall portion thickness T_{B}. Because the thickness TR of the wall portions, closer to the signal electrodes 3, of the gas discharge tubes 11R and 12R is larger than the tube wall thickness T_{B}, the firing voltage for opposite discharge between the signals electrodes 3 of the gas discharge tubes 11R and 12R and the display electrode 2 rises by about 5V from about 280 V according to the increased thickness. Because the thickness T_{G} of the wall portions, closer to the signal electrodes 3, of the gas discharge tubes 11G and 12G is smaller than the tube wall portion thickness T_{B}, the firing voltage for opposite discharge between the signal electrodes 3 of the gas discharge tubes 11G and 12G and the display electrode 2 decreases by about 15 V from about 310 V according to the decreased thickness. Thus, the difference in firing voltage for opposite discharge, between the gas discharge tubes 11R, 11G, 11B, . . . , becomes smaller to about 10 V.

FIG. 7 shows the cross-section of the structure of a display device 110 in a plane perpendicular to the longitudinal direction, in accordance with a still further embodiment of the invention. In FIG. 7, the width W_{R} of those flat portions of the red-emitting gas discharge tubes 11R and 12R which contact the display electrodes 2, is, for example, 0.25 mm. The width W_{G} of those flat portions of the green-emitting gas discharge tubes 11G and 12G which contact the display electrodes 2 is larger and, for example, 0.5 mm. The width W_{B} of those flat portions of the blue-emitting gas discharge tubes 11B and 12B which contact the display electrodes 2 is larger than the width W_{R} of those flat portions of the gas discharge tubes 11R and 12R which contact the display electrodes 2 and smaller than the width W_{G} of those flat portions of the gas discharge tubes 11G and 12G which contact the display electrodes 2, and is, for example, 0.3 mm.

The firing voltage for opposite discharge for the gas discharge tubes 11B and 12B is about 290 V for the width W_{B} of the flat portions contacting the display electrodes 2. Because the width W_{R} of the flat portions of the gas discharge tubes 11R and 12R contacting the display electrodes 2 is smaller than the width W_{B}, the firing voltage for opposite discharge between the signal electrodes 3 for the discharge tubes 11R and 12R and the display electrodes 2 increases by about 10 V, from about 280 V up to about 290 V according to the decreased width. Because the width W_{G} of the flat portions of the gas discharge tubes 11G and 12G contacting the display electrodes 2 is larger than the width W_{B}, the firing voltage for opposite discharge between the signal electrodes 3 for the discharge tubes 11G and 12G and the display electrodes 2 decreases by about 10 V, from about 310 V down to about 300 V according to the increased width. Thus, the difference in firing voltage for opposite discharge, between the gas discharge tubes 11R, 11G, 11B, . . . , becomes smaller to about 10 V.

FIG. 8 shows the cross-section of the structure of a display device 112 in a plane perpendicular to the longitudinal direction, in accordance with a still further embodiment of the invention. In FIG. 8, the thin tubes 20R for the red-emitting discharge tubes 11R and 12R are made of a material having a smaller dielectric constant ε, which may be, for example, quartz having a dielectric constant ε_{R}=3.9. The thin tubes 20G for the red-emitting discharge tubes 11G and 12G are made of a material having a larger dielectric constant ε, which may be, for example, soda lime glass having a dielectric constant ε_{G}=6.0. The thin tubes 20B for the blue-emitting discharge tubes 11B and 12B are made of a material having a dielectric constant ε larger than that of the material for the thin tubes 20R and smaller than that of the material for the thin tubes 20G, and is, for example, Pyrex® having a dielectric constant ε_{B}=4.6. The discharge tubes 11R, 11G and 11B have a tube wall thickness of, for example, 100 μm, and a height of 0.5 mm and a width of 1.0 mm in the cross-section perpendicular to the longitudinal direction.

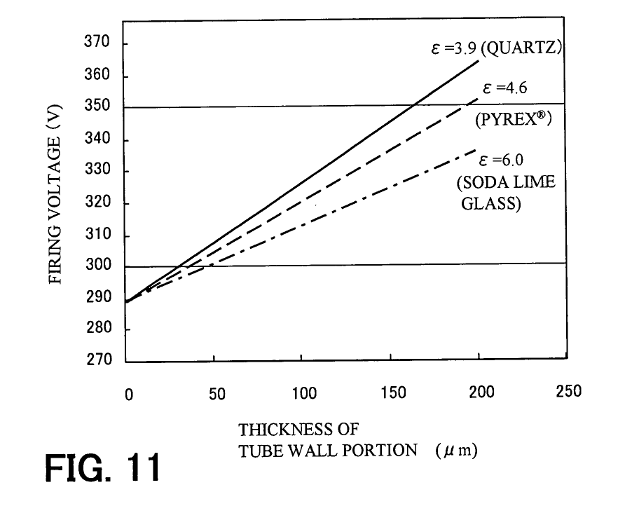

FIG. 11 shows the firing voltages for opposite discharge between one display electrode 2 and the signal electrodes 3 in the green-emitting gas discharge tube 11G. The opposite discharge firing voltage differs depending on the material for discharge tubes, and increases with the thickness of the tube wall. In the case of FIG. 11, the firing voltage for the discharge tube 11G, whose material is quartz, is about 325 V, the firing voltage for the discharge tube 11G, whose material is Pyrex®, is about 320 V, and the firing voltage for the discharge tube 11G, whose material is soda lime glass, is about 312 V.

The firing voltage for opposite discharge for the gas discharge tubes 11R and 12R is, for example, about 295 V, for the thin tubes 20R having a small dielectric constant ε_{R}. By virtue of using the thin tubes 20G made of a material having the largest dielectric constant ε_{G}, the firing voltage for opposite discharge between the signal electrodes 3 for the gas discharge tubes 11G and 12G and the display electrodes 2 is, for example, 302 V. By virtue of using the thin tubes 20B made of a material having the intermediate dielectric constant ε_{B}, the firing voltage for opposite discharge between the signal electrodes 3 for the gas discharge tubes 11B and 12B and the display electrodes 2 is, for example, 300 V. Thus, the difference in firing voltage for opposite discharge, between the gas discharge tubes 11R, 11G, 11B, . . . , becomes smaller to about 7 V.

The above-described embodiments are only typical examples, and their combination, modifications and variations are apparent to those skilled in the art. It should be noted that those skilled in the art can make various modifications to the above-described embodiments including application to a common color plasma display panel of a three-electrode surface discharge type, without departing from the principle of the invention and the accompanying claims.

What is claimed is:

1. A color display device comprising: a plurality of gas discharge tubes disposed side by side, said gas discharge tubes having phosphor layers of different materials for respective colors disposed therein and containing discharge gas therein, said gas discharge tubes each having a plurality of light-emitting points disposed along the length thereof; a plurality of display electrodes disposed on display-side surfaces of said gas discharge tubes; and a plurality of signal electrodes disposed on the rear sides of said respective gas discharge tubes; wherein
those ones of said gas discharge tubes which include a same, particular material in the phosphor layers thereof have voltage adjusting layers disposed between rear surfaces and the signal electrodes thereof, said voltage adjusting layers being made of a material which adjusts a firing voltage for discharge between the display electrodes and the signal electrodes, and
the thicknesses of said voltage adjusting layers for said plurality of gas discharge tubes including said different materials in the respective phosphor layers thereof are so selected as to reduce differences in firing voltage, among said plurality of gas discharge tubes.

2. A color display device comprising: a plurality of gas discharge tubes disposed side by side, said gas discharge tubes having phosphor layers of different materials for respective colors disposed therein and containing discharge gas therein, said gas discharge tubes each having a plurality of light-emitting points disposed along the length thereof; a plurality of display electrodes disposed on display-side surfaces of said gas discharge tubes; and a plurality of signal electrodes disposed on the rear sides of said respective gas discharge tubes;
wherein dimensions of said gas discharge tubes are so selected, depending on the materials of said respective phosphor layers, as to reduce differences in firing voltage for discharge between said display electrodes and said signal electrodes in said plurality of gas discharge tubes.

3. The color display device according to claim 2, wherein the dimensions are at least one of a distance between display-side and rear-side surfaces of said gas discharge tubes, a thickness of a rear-side tube wall portion of said gas discharge tubes, and a width of a flat portion of display-side surfaces of said gas discharge tubes, said distance, thickness and width being measured in a cross-section perpendicular to the longitudinal direction of said discharge tubes.

4. A color display device comprising: a plurality of gas discharge tubes disposed side by side, said gas discharge tubes having phosphor layers of different materials for respective colors disposed therein and containing discharge gas therein, said gas discharge tubes each having a plurality of light-emitting points disposed along the length thereof; a plurality of display electrodes disposed on display-side surfaces of said gas discharge tubes; and a plurality of signal electrodes disposed on the rear sides of said respective gas discharge tubes;
wherein the widths of said signal electrodes for said gas discharge tubes are so selected for the materials of said respective phosphor layers, as to reduce differences in firing voltage for discharge between said display electrodes and said signal electrodes in said plurality of gas discharge tubes.

5. A color display device comprising: a plurality of gas discharge tubes disposed side by side, said gas discharge tubes having phosphor layers of different materials for respective colors disposed therein and containing discharge gas therein, said gas discharge tubes each having a plurality of light-emitting points disposed along the length thereof; a plurality of display electrodes disposed on display-side surfaces of said gas discharge tubes; and a plurality of signal electrodes disposed on the rear sides of said respective gas discharge tubes;
wherein materials of said gas discharge tubes are so selected for the materials of said respective phosphor layers, as to reduce differences in firing voltage for discharge between said display electrodes and said signal electrodes in said plurality of gas discharge tubes.
